(19) United States
(12) Patent Application Publication
(10) Pub. No.: US 2014/0195917 A1
(43) Pub. Date: Jul. 10, 2014

(54) DETERMINING START AND END POINTS OF A VIDEO CLIP BASED ON A SINGLE CLICK

(71) Applicant: TAKES LLC, Wilmington, DE (US)

(72) Inventor: Amit MAN, Tel Aviv (IL)

(73) Assignee: Takes LLC, Wilmington, DE (US)

(21) Appl. No.: 13/734,981

(22) Filed: Jan. 6, 2013

(51) Int. Cl. G06F 3/048

(52) U.S. Cl. CPC G06F 3/048
USPC 715/723

(57) ABSTRACT

A method of capturing a video clip in a single ‘click’ is provided herein. The method includes the following steps: capturing a multimedia file; obtaining kinematic data related to the capturing; indicating, by a user action, a snapshot moment, being a timestamp, on the multimedia file; applying a decision function, wherein the decision function receives as an input at least one of: the captured multimedia file, the snapshot moment, and the kinematic data and yields as an output: a start point, being a timestamp on the multimedia file that precedes the snapshot moment and an end point, being a timestamp that follows the snapshot moment.

### FIELD OF THE INVENTION

The present invention relates generally to image and video processing, and more particularly for applying data external to the image and video, in the processing thereof.

### BACKGROUND OF THE INVENTION

As video capturing using smartphones becomes very popular, more and more methods are being developed to improve and enhance both the quality of these videos and the overall user experience of the capturing process. Current smartphones usually offer either still images capturing or video capturing wherein the two different modes are selectable by the user.

### BRIEF SUMMARY OF EMBODIMENTS OF THE INVENTION

According to one aspect of the present invention, a method of capturing a video clip in a single ‘click’ is provided herein. The method includes the following steps: capturing a multimedia file; obtaining kinematic data related to the capturing; indicating a snapshot moment, being a timestamp on the multimedia file responsive to a user action; applying a decision function, wherein the decision function receives as an input at least one of: the captured multimedia file, the snapshot moment, and the kinematic data and yields as an output: a start point, being a timestamp on the multimedia file that precedes the snapshot moment and an end point, being a timestamp that follows the snapshot moment.

According to another aspect of the present invention, a system for capturing a video clip in a single ‘click’ is provided herein. The system includes a capturing device configured to capture a multimedia file; a motion sensor physically coupled to the capturing device configured to extract kinematic data related to the capturing; a computer processor configured to: indicate a snapshot moment, being a timestamp, on the multimedia file responsive to a user action; apply a decision function, wherein the decision function receives as an input at least one of: the captured multimedia file, the snapshot moment, and the kinematic data and yields as an output: a start point, being a timestamp on the multimedia file that precedes the snapshot moment and an end point, being a timestamp that follows the snapshot moment.

These additional, and/or other aspects and/or advantages of the present invention are set forth in the detailed description which follows.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram of a system for making a video based on a still image capturing process according to embodiments of the present invention;

FIG. 2 is a high level flowchart of a method for making a video based on a still image capturing process according to embodiments of the present invention;

FIG. 3 is a schematic illustration of a system for making a video based on a still image capturing process according to embodiments of the present invention;

FIG. 4 is a schematic illustration of an exemplary timeline of multimedia data captured by a camera according to embodiments of the present invention; and

FIG. 5 is a schematic illustration of a selection, according to embodiments of the present invention, of a portion of multimedia data captured during a capturing process period.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Embodiments of the present invention may enable a user to create a video clip while capturing still images in a usual manner. While it is possible according to embodiments of the present invention to create video clips, the captured still image may be stored and may still be watched as regular still image. The capturing experience may be the same as image capturing, i.e., a usual still images capturing experience. Thus, embodiments of the present invention may enable creation of video clips in a very quick and/or convenient manner.

Embodiments of the present invention provide a method for capturing a video clip while taking a still image, based on data recorded during the image capturing process. Typically, embodiments of the present invention are applicable for mobile devices that include a camera and optionally may include additional sensors and/or detection abilities, such as, for example, mobile phones, camera phones, tablet computers, etc. However, the present invention is not limited to any specific kind of devices. The terms “movie” and “video” may be used interchangeably in the present document and their meaning may be a seemingly moving picture or any other meaning that is common in the art. Additionally, the terms “picture”, “image” and “photo” may be used interchangeably in the present document.

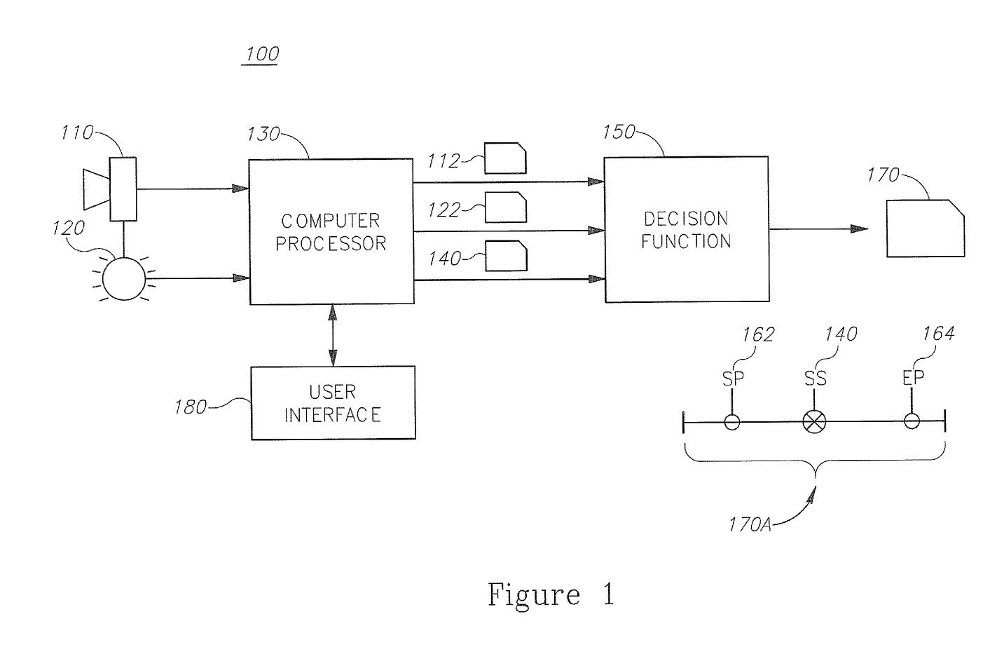

FIG. 1 is a block diagram illustrating a system 100 in accordance with some embodiments of the present invention. System 100 may include, for example, a capturing device 110 configured to capture a multimedia file 112, a motion sensor 120, a computer processor 130 and a user interface 180. Motion sensor 120 may be physically coupled to capturing device 110, and/or may be configured to obtain kinematic data 122 related to the capturing. Computer processor 130 may be configured to indicate a snapshot moment 140, being a timestamp on multimedia file 112 responsive to a user action, which may be made for example, by user interface 180. Additionally, computer processor 130 may be configured to apply a decision function 150, wherein decision function 150 may receive as an input at least one of: multimedia file 112, snapshot moment 140, and kinematic data 122 and/or may yield as an output: a start point 162, being a timestamp on multimedia file 112 that precedes snapshot moment 140 and/or an end point 164, being a timestamp that follows snapshot moment 140.

According to some embodiments of the present invention, computer processor 130, in operative association with the decision function 150 that may be executed by computer processor 130, may generate a multimedia clip 170 that may include snapshot moment 140 and may be a subset of the recorded multimedia segment 170A included in captured multimedia file 112, wherein multimedia clip 170 may start with start point 162 and/or end with end point 164 yielded by decision function 150.

According to some embodiments of the present invention, multimedia file 112 may include a video sequence and wherein snapshot moment 140 may be associated with a single still image. Additionally, multimedia file 112 may also include an audio sequence and wherein snapshot moment 140 may be associated with a single moment within the audio clip.

According to some embodiments of the present invention, multimedia file 112 may include both a video sequence and an audio sequence and wherein the video sequence and the audio sequence may each be associated with respective start points and/or end points and/or a common snapshot moment. More specifically, the start and end points of the audio sequence may be different from the start and end points of the video sequence.

According to some embodiments of the present invention, decision function 150 may further receive as an input at least one of: metadata relating to the user and to the capturing context. More specifically, decision function 150 may further apply at least one of: image processing algorithms and audio processing algorithms which may be taken into account in determining the start points and the end points.

It should be noted that the applying of the decision function may be carried out off-line, after the capturing of the multimedia file has ended, for example in order to provide better results. However, it may also be applied in real time.

Decision function 150 may filter out portions of multimedia file 112 that are below a predefined level of a specified qualitative metric. In one embodiment, the kinematic data may be transformed into a spatial path of the capturing device, which may be fed into the decision function. In one embodiment, the decision function may compare the kinematic data to a list of predefined thresholds. In one embodiment, in a case that the multimedia files contain an audio sequence, the decision function may apply at least one of the following audio signal processing: voice recognition algorithms, various detection of impulsive sound signal algorithms, volume peak detection and/or pitch detection. Accordingly, the start points and the end points of the audio and the video clips derived from a common multimedia file, may be different.

In another embodiment, the indicating of the snapshot moment may be repeated a plurality of times, for example to yield a plurality of snapshot moments, and/or wherein the user action is initiated after the multimedia has been captured in its entirety.

According to some embodiments, computer processor 130 is further configured to tag the multimedia clip with a tag indicative of data derived from the still image. Additionally, computer processor 130 is further configured to apply a predefined operation to a sequence of multimedia clips containing the generated multimedia clip, based on the tag. Alternatively, some of the tagging-related processes such as analysis and data processing may be carried out on a server remotely connected to system 100. More specifically, computer processor 130 may be further configured to apply a search operation for the multimedia clip, based on the tag.

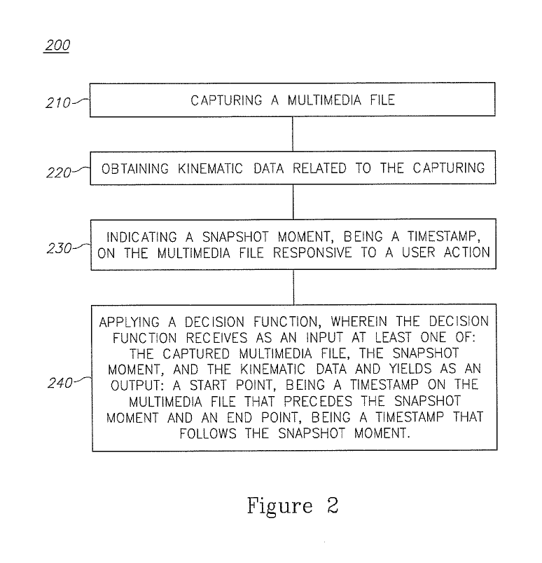

FIG. 2 is a high level flowchart illustrating a method according to some embodiments of the present invention. Method 200 starts off with the step of a capturing a multimedia file 210. Then, the method goes on to the step of obtaining kinematic data related to the capturing 220. Then, the method proceeds to indicating, by a user action, a snapshot moment, being a timestamp, on the multimedia file 230. Then the method goes on to the step of applying a decision function, wherein the decision function receives as an input at least one of: the captured multimedia file, the snapshot moment, and the kinematic data and yields as an output: a start point, being a timestamp on the multimedia file that precedes the snapshot moment and an end point, being a timestamp that follows the snapshot moment 240.

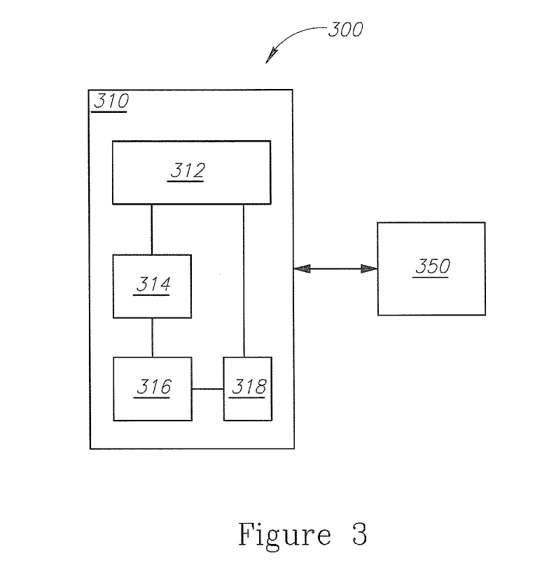

Reference is now made to FIG. 3, which is a schematic illustration of another exemplary system 300 for making a video based on a still image capturing process according to embodiments of the present invention. It should be noted here that any reference herein to video should include also audio and the process of video sequence generation includes the audio sequence generation that accompanies it.

System 300 may include a device 310 that may constitute, for example, a mobile phone, a smartphone, a camera phone, a tablet computer or any other suitable device. Device 310 may include a processor 312, a memory 314, a camera 316, a user interface 318, audio recorder (not shown) and an acceleration sensor (not shown) such as, for example, a three-axis gyroscope and/or an accelerometer. Additionally, system 300 may include an application server 350, which may be in internet communication with device 10, for example over wireless and/or cellular connections.

Device 310 may receive from application server 350 software items such as, for example, code and/or objects that may enable the making of a movie based on a still image capturing process according to embodiments of the present invention. For example, such software items may be downloaded and stored in memory 314 automatically or following a user command entered by user interface 318. For example, such software items may be downloaded and stored in memory 314 before and/or during the process of making a video based on a still image capturing data according to embodiments of the present invention. Memory 314 may include an article such as a computer or processor readable non-transitory storage medium, such as for example a memory card, a disk drive, or a USB flash memory encoding, including or storing instructions, e.g., computer-executable instructions, such as, for example, the software items downloaded from application server 350. When executed by a processor or controller such as processor 312, the instructions stored and/or included in memory 314 may cause the processor or controller to carry out methods disclosed herein.

In certain embodiments of the present invention, some of the processing required according to embodiments of the present invention may be executed in application server 350. For example, during execution of methods according to embodiments of the present invention, application server 350 may receive data, information, request and/or command from device 310, process the data, and send the processed data and/or any requested data back to device 310.

Camera 316 may include a light sensor of any suitable kind and an optical system, which may include, for example, one or more lenses. User interface 318 may include software and/or hardware instruments that may enable a user to enter commands into device 310, control device 310, receive and/or view data from device 310, etc, such as, for example, a screen, a touch screen, a keyboard, buttons, audio input, audio recording software and hardware, voice recognition software and hardware, vocal/visual indications by device 310 and/or any other suitable user interface software and/or hardware.

By user interface 318 a user may, for example, take pictures by camera 316 and/or control camera 316. Pictures taken by camera 316, along with accompanying data, may be stored at memory 314. According to embodiments of the present invention, taking a picture by camera 316 may involve production of a multimedia file (e.g., a video and/or an audio file) associated with each one of the taken pictures. For example, the multimedia file according to embodiments of the present invention may include the multimedia data of the taken picture along with additional data such as, for example, video or audio data recorded during, before and/or after the actual capturing moment of the picture. The data included in the multimedia file may be recorded during a time period starting before the capturing moment and ending after the capturing moment, which may be regarded as the capturing process period of time. For example, the capturing process period may start once camera 316 is initiated and ready to take a picture. The capturing process period may end, for example, once the camera is ready to take another picture, e.g. a few seconds or less after a picture is taken, or, for example, once the camera stops running, such as, for example, when it is logged out or turned off, or the screen of device 310 is shut down. Accordingly, the multimedia file may include, for example, image data captured during, before and/or after the actual capturing moment. Additionally, the data file may include, for example, audio data recorded by audio recorder during, before and/or after the actual capturing moment. Additionally, the capturing process file may include information about location, position, acceleration and/or velocity of the device during, before and after the actual capturing moment, that may be gathered, for example, by acceleration sensor. It is therefore an aspect of the present invention to determine, for each capturing moment, a start point and an end point of the corresponding video or audio clip.

The capturing moment may be the moment when a picture is taken following a user command. Usually, the capturing moment occurs a short while after a user touches or pushes the camera button in order to take a picture, usually but not necessarily after a certain shutter lag period that may be typical for the device and/or may depend on the environmental conditions such as, for example, lighting of the imaged environment, movement and/or instability of the device, etc.

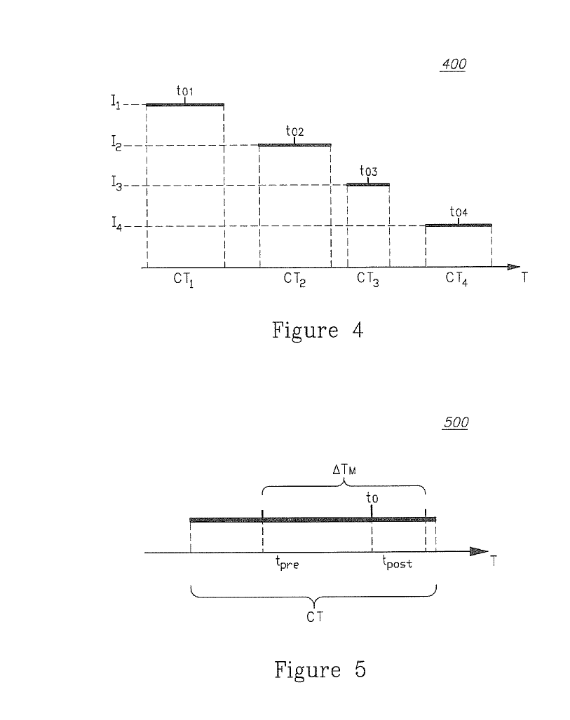

Reference is now made to FIG. 4, which is a schematic illustration of an exemplary timeline 400 of image data captured by a camera according to embodiments of the present invention, for example by camera 316. For the sake of simplicity, the audio files are omitted her but it is understood that a similar mechanism for generating video files may be provided for audio files so that an ordered set of audio files, each with its own start point and end point determined based on the capturing moment and various other context related data may be also provided.

By way of example, and without limitation, relating to video clips only, a user may capture several images I₁, I₂, I₃ and I₄ and so forth along time, shown in FIG. 4 by an axis T. Although FIG. 4 refers to four images I₁, I₂, I₃ and I₄, the invention is not limited in that respect and any other number of images can be used according to embodiments of the present invention. According to embodiments of the present invention, as discussed above, each taken picture I₁, I₂, I₃ and I₄ and so on may be stored as image data along with multimedia recorded during, before and/or after the actual capturing moments t₀₁, t₀₂, t₀₃, and t₀₄ of the pictures, respectively. As discussed above, processor 312 may record capturing process data, which may include data recorded during a capturing process period. As discussed above, the capturing process data may additionally include data about location, orientation, acceleration, velocity of the device and/or any other suitable data that may be recorded during the capturing process period. Accordingly, the multimedia data may be recorded during a time period starting before the capturing moment and ending after the capturing moment, which may be regarded as the capturing process period of time, shown in FIG. 4 as CT₁, CT₂, CT₃ or CT₄, respectively. As discussed above, the capturing process period CT₁, CT₂, CT₃ or CT₄ may start once camera 316 is initiated and ready to take a picture. The capturing process period CT₁, CT₂, CT₃ or CT₄ may end, for example, once the camera is ready to take another picture, e.g. a few seconds or less after a picture is taken, or, for example, once the camera stops running, such as, for example, when it is logged out or turned off, or the screen of device 310 is shut down. Accordingly, the multimedia file may include, for example, the captured image data, an audio data and a capturing process metadata. The captured image data file may include the multimedia data of the captured image. The video data file may include image data captured during, before and/or after the actual capturing moment t₀₁, t₀₂, t₀₃, or t₀₄, The capturing process data file may include capturing process data such as, for example, information about location, position, orientation, acceleration (spatial and/or angular) and/or velocity (spatial and/or angular) of the device during, before and after the actual capturing moment, e.g. during the capturing process period.

According to embodiments of the present invention, processor 312 and/or application server 350 may receive a multimedia file related to an originally captured image such as I₁, I₂, I₃ or I₄, and may produce a video segment by selecting a portion of the multimedia data recorded during the capturing process period. According to embodiments of the present invention, processor 312 may select a portion of the multimedia data in order to obtain an multimedia segment containing data that may be relevant to the captured still image and may be relatively smooth and convenient to watch. The selection of the portion may be based on predetermined data and/or criteria that may be determined in order to identify a portion of the image data that may be consistent with the user's intentions when capturing the image. For example, processor 312 may identify, based on predetermined criteria, a portion of the image data that may be relatively consistent and continuous with respect to the original captured picture. It will be appreciated that some or all of the operations described in the present document as being executed by processor 312 may be alternatively or additionally executed by application server 350.

Reference is now made to FIG. 5, which is a schematic illustration of a selection, shown as a time line 500 according to embodiments of the present invention, of a portion ΔT_{M} of image data captured during a capturing process period CT. Again, for the sake of simplicity, audio files are not shown here and are basically treated similarly to video clips—each audio file is stored separately as the generation of the video sequence involves both video clips and audio clips joined together wherein an overlap between video clips and audio clips captured together is not necessary.

Axis T in FIG. 5 represents time. Processor 312 may select a portion ΔT_{M} of the multimedia data recorded during the capturing process period CT, at capturing moment t₀. Portion ΔT_{M} may include the capturing moment t₀ itself, a period of time tₚᵣₑ, which is a period of time before the capturing moment t₀ and/or a period of time tₚₒₛₜ, which is a period of time after the capturing moment t₀.

As mentioned above, the selection of portion ΔT_{M} may be based on predetermined data and/or criteria that may be determined in order to identify a portion of the image data that may be consistent with the user's intentions when capturing the image. For example, processor 312 may identify, based on predetermined criteria, a portion of the image data that may be relatively consistent and continuous with respect to the original captured picture. Processor 312 may analyze predetermined data of the capturing process data. In some embodiments of the present invention, processor 312 may analyze the device movement during the capturing process period, for example, based on data about location, orientation, acceleration, velocity of the device that was recorded during the capturing process period and included in a metadata file. Processor 312 may analyze the metadata and recognize, for example, a portion of the capturing process period when the movement is relatively smooth and/or monotonic, e.g. without sudden changes in velocity and/or orientation, for example according to a predetermined threshold of amount of change in velocity and/or orientation. Additionally, processor 312 may identify a path of the device in space. The path of the device in space may be relative to predefined constrains such as ‘a path entirely above waist level of the user’.

The path may be retrieved, for example, based on data about location and orientation of the device that was recorded during the capturing process period and included in the capturing process data file. Processor 312 may analyze the recorded and identified path and determine, for example, a portion of the capturing process period in which the path is relatively continuous and/or fluent. Relative fluency and/or continuousness may be recognized according to a predetermined threshold of change amount, for example, in direction and/or location. Additionally, processor 312 may analyze the image data recorded on, before and/or after the capturing moment and recognize transition moments in the image data, such as relative sudden changes in the imaged scene. Relative sudden changes in the imaged scene may be recognized, for example, according to a predetermined threshold of change amount in the video data clip.

Based on the analyses of the recorded data, processor 312 may select a portion of the recorded multimedia data, for example based on predetermined criteria. For example, it may be predetermined that the selected portion should include the original captured picture. Other suitable analyses and criteria may be included in the method in order to select the image data portion that may mostly suit the user's intention when taking the picture. The selected portion may constitute a video segment that may be associated with the original taken picture. Accordingly, a plurality of video segments selected according to embodiments of the present invention may each be stored, for example in memory 314, with association to multimedia data of the respective original captured image. It should be noted that the aforementioned analysis and generation can preferably be carried out off-line, after the capturing sessions are over and when there is plenty of time and metadata to reach optimal generation of video clips and audio clips based on the capturing moments.

Alternatively, in some embodiments of the present invention, the analysis of the data and the selection of the image data portion may be performed in real time, e.g. during the capturing process. For example, during the capturing process, processor 312 may recognize relative sudden changes in velocity and/or orientation, and may select the portion when the movement is relatively smooth and/or monotonic. Additionally, during the capturing process, processor 312 may recognize transition moments in the image data, such as relative sudden changes in the imaged scene. Therefore, in some embodiments of the present invention, processor 312 may select in real time a portion of the recorded image data that does not include relative sudden changes in the imaged scene, that includes a relatively fluent and/or continuous path of the device in space and/or that does not include sudden changes in velocity and/or orientation.

Additionally, according to some embodiments of the present invention, processor 312 may learn the picture capturing habits of a certain user, for example a user that uses device 310 most frequently. For example, in some cases, a user may usually take pictures with a very short tₚᵣₑ before the picture is taken, or may have more or less stable hands and/or any other suitable shooting habits that may affect the criteria and/or thresholds used in selection of the most suitable portion of the image data. Based on the user's habits, processor 312 may regenerate criteria and/or thresholds according to which a most suitable portion of the image data may be selected.

In some embodiments of the present invention, processor 312 may select along with a portion of the video data, a suitable portion of audio data recorded by device 310. The selection may be performed according to predetermined criteria. For example, it may be predetermined that the selected portion of recorded audio data includes audio data that was recorded at the capturing moment or proximate to the capturing moment. Additionally, for example, it may be predetermined that the selected portion of recorded audio data does not include a cutting off of a speaking person.

In some embodiments, the selected video segments, possibly along with the selected audio segments, may be joined sequentially to create a joined video. In such cases, a video segment may continue along more than one video segment, and/or, for example, begin within one video segment and end within another video segment of the joined video segments.

According to embodiments of the present invention a user may select, for example by user interface 318, a plurality of captured images that he wishes to transform to a combined video. Additionally, the user may select the order in which the selected images should appear in the video.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method comprising:
capturing a multimedia file;
obtaining kinematic data related to the capturing;
indicating, by a user action, a snapshot moment, being a timestamp, on the multimedia file; and
applying a decision function, wherein the decision function receives as an input at least one of: the captured multimedia file, the snapshot moment, and the kinematic data and yields as an output: a start point, being a timestamp on the multimedia file that precedes the snapshot moment and an end point, being a timestamp that follows the snapshot moment.

2. The method according to claim 1, further comprising generating a multimedia clip being a subset of the captured multimedia file, wherein the multimedia clip starts with the start point, comprises the snapshot moment, and ends with the end point.

3. The method according to claim 1, wherein the multimedia file contains a video sequence and wherein the snapshot moment is associated with a single still image.

4. The method according to claim 1, wherein the multimedia file contains an audio sequence and wherein the snapshot moment is associated with an audio clip.

5. The method according to claim 1, wherein the multimedia file comprises both a video sequence and an audio sequence and wherein the video sequence and the audio sequence are each associated with respective start points and end points and a common snapshot moment.

6. The method according to claim 1, wherein the decision function further receives as an input at least one of: metadata relating to the user and to the capturing context.

7. The method according to claim 1, wherein the decision function further applies at least one of: image processing algorithms, and audio processing algorithms which are taken into account in determining the start points and the end points.

8. The method according to claim 1, wherein the applying of the decision function is carried out off-line, after the capturing of the multimedia file has ended.

9. The method according to claim 1, wherein the decision function filters out portions of the multimedia file that are below a predefined level of a specified qualitative metric.

10. The method according to claim 1, wherein the kinematic data are transformed into a spatial path of the capturing device, which is fed into the decision function.

11. The method according to claim 1, wherein the decision function compares the kinematic data to a list of predefined thresholds.

12. The method according to claim 1, wherein in a case that the multimedia files comprise an audio sequence, the decision function applies at least one of audio signal processing.

13. The method according to claim 1, wherein the indicating is repeated a plurality of times, to yield a plurality of snapshot moments, and wherein the user action is initiated after the multimedia has been captured in its entirety.

14. The method according to claim 6, wherein the metadata is based upon a still image associated with the snapshot moment.

15. The method according to claim 1, further comprising tagging the multimedia clip with a tag indicative of data derived from a still image contained within the multimedia file and associated with the snapshot moment.

16. The method according to claim 15, further comprising applying a predefined operation to the multimedia clip, based on the tag.

17. The method according to claim 16, further applying a search operation for the multimedia clip, based on the tag.

18. A system comprising:
a capturing device configured to capture a multimedia file;
a motion sensor physically coupled to the capturing device configured to obtain kinematic data related to the capturing;
a user interface configured to indicate a snapshot moment, being a timestamp, on the multimedia file responsive to a user action; and
a computer processor configured to apply a decision function, wherein the decision function receives as an input at least one of: the captured multimedia file, the snapshot moment, and the kinematic data and yields as an output: a start point, being a timestamp on the multimedia file that precedes the snapshot moment and an end point, being a timestamp that follows the snapshot moment.

19. The system according to claim 18, wherein the computer processor is further configured to generate a multimedia clip being a subset of the captured multimedia file, wherein the multimedia clip starts with the start point, comprises the snapshot moment, and ends with the end point.

20. The system according to claim 18, wherein the multimedia file contains a video sequence and wherein the snapshot moment is associated with a single still image.

21. The system according to claim 18, wherein the multimedia file contains an audio sequence and wherein the snapshot moment is associated with an audio clip.

22. The system according to claim 18, wherein the multimedia file comprises both a video sequence and an audio sequence and wherein the video sequence and the audio sequence are each associated with respective start points and end points and a common snapshot moment.

23. The system according to claim 18, wherein the decision function further receives as an input at least one of: metadata relating to the user and to the capturing context.

24. The system according to claim 18, wherein the decision function further applies at least one of: image processing algorithms, and audio processing algorithms which are taken into account in determining the start points and the end points.

25. The system according to claim 18, wherein the applying of the decision function is carried out off-line, after the capturing of the multimedia file has ended.

26. The system according to claim 18, wherein the decision function filters out portions of the multimedia file that are below a predefined level of a specified qualitative metric.

27. The system according to claim 18, wherein the kinematic data are transformed into a spatial path of the capturing device, which is fed into the decision function.

28. The system according to claim 18, wherein the decision function compares the kinematic data to a list of predefined thresholds.

29. The system according to claim 18, wherein in a case that the multimedia files comprise an audio sequence, the decision function applies at least audio signal processing.

30. The system according to claim 18, wherein the indicating is repeated a plurality of times, to yield a plurality of snapshot moments, and wherein the user action is initiated after the multimedia has been captured in its entirety.

31. The system according to claim 22, wherein the metadata is based upon a still image associated with the snapshot moment.

32. The system according to claim 18, further comprising tagging the multimedia clip with a tag indicative of data derived from a still image contained within the multimedia file and associated with the snapshot moment.

33. The method according to claim 29, further comprising applying a predefined operation to the multimedia clip, based on the tag.

34. The method according to claim 29, further applying a search operation for the multimedia clip, based on the tag.
